(19) United States
(12) Patent Application Publication
(10) Pub. No.: US 2005/0083398 A1
(43) Pub. Date: Apr. 21, 2005

(54) Plate scanning system with field replaceable laser source subsystem

(75) Inventors: Stephen Felix Sagan, Lexington, MA (US); Torsten Volker Platz, Cambridge, MA (US)

Correspondence Address: AGFA CORPORATION;LAW & PATENT DEPARTMENT, 200 BALLARDVALE STREET, WILMINGTON, MA, 01887, US

(73) Assignee: Agfa Corporation, Wilmington, MA (US)

(21) Appl. No.: 10/686,901

(22) Filed: Oct. 16, 2003

(51) Int. Cl. B41J 27/00

(52) U.S. Cl. 347/258

(57) ABSTRACT

A design for pre-scan optics offers the possibility of low cost field modularity by replacing a rather inexpensive optical sub-module inside the pre-scan optics instead of the entire optics bench in the case of laser failure in a platesetter or imagesetter. It further allows the use of lenses that are highly dispersive and are designed to operate at other wavelengths, such as 780 nm. The correction is distributed over three elements. This allows for collimation in both the X and Y axes of the beam.

### BACKGROUND OF THE INVENTION

Imagesetters and platesetters are used to expose media that are used in offset printing systems. Imagesetters are typically used to expose the film that is then used to make the plates for the printing system. Platesetters are used to directly expose the plates.

For example, plates are typically large substrates that have been coated with photosensitive or thermally-sensitive material layers, referred to as the emulsion. For large run applications, the substrates are fabricated from aluminum, although organic substrates, such as polyester or paper, are also available for smaller runs.

Computer-to-plate printing systems are used to render digitally stored print content onto these printing plates. Typically, a computer system is used to drive an imaging engine of the platesetter. In a common implementation, the plate is fixed to the outside or inside of a drum or held on a flat bed and then scanned with a modulated laser source in a raster fashion.

The imaging engine selectively exposes the emulsion that is coated on the plates with the desired image. After this exposure, the emulsion is developed so that, during the printing process, inks will selectively adhere to the plate's surface to transfer the ink to the print medium.

The imaging engine exposure systems of these platesetters and/or imagesetters must have highly optimized and calibrated optical systems. A light dot, generated typically by a laser, is used to expose the printing media. Its size at the image plane or the printing media must be well controlled over the life of the machine and over the entire scan in order to ensure that the system's performance or resolution does not degrade and is constant across the width of the plate. In many systems, a specially-designed beam shaping subsystem is used to collimate the beam from the laser source. The collimated beam is then provided to a scanning subsystem that scans the beam over the printing media.

### SUMMARY OF THE INVENTION

One problem that arises in these conventional systems is that the beam shaping sub-systems tend to be relatively large and inflexible. They are typically designed and optimized in order to generate highly collimated beams from the laser. Typically, semiconductor lasers are used in which the beams are highly diverging, challenging the design of the optics. Thus, in order to collimate these beams, relatively large optical bench-type systems are specially manufactured and calibrated in order to generate the desired beam characteristics.

This conventional approach to configuring the beam shaping subsystems raises a number of problems. First, these optical bench systems are typically expensive to produce. Moreover, because of their fixed nature, they cannot be adapted to address long-term changes in the system. Simply, they typically do not allow for much recalibration to adapt to changes in the laser diode or other optics in the system. Finally, if the laser diode should fail, this entire, expensive optical bench system must often be replaced.

One current design uses a fixed focal length collimator in order to collimate the output of a 30 milliwatt violet laser diode in combination with a cemented cylindrical achromatic lens-doublet, which provides for axial color correction with changing diode wavelength over the range of 400-410 nm.

In case of a dying laser diode, which is by far the most probable field-failure, the current design of the pre-scan optics does not offer field modularity on a low cost base. If the laser diode has to be replaced, the entire optics bench has to be exchanged since any slight misalignment of the diode-collimator distance would result in an astigmatic focus shift and degrade the image quality. Besides, in order to compensate for axial focus shift as a result of laser diode wavelength changes, a sophisticated color corrected design for the pre-scan optics was used.

The present invention is directed to a design for the pre-scan optics, which offers the possibility of low cost field modularity by replacing a rather inexpensive optical sub-module inside the pre-scan optics instead of the entire optics bench.

In general, according to one aspect, the invention features a media exposure system. It comprises a field-replaceable laser source sub-system that generates an exposure beam. A beam shaping sub-system then shapes this exposure beam. Finally, a scanning sub-system scans the exposure beam over the printing media.

The advantage is that, in the case of a laser diode failure, only the laser source together with a lens must be replaced. Moreover, the lens can be an inexpensive off-the-shelf, commercially available, element. The beam shaping sub-system, which collimates the beam from the laser, can be maintained in the unit, reducing the cost for servicing such a failure.

In the preferred embodiment, the field-replaceable laser source sub-system comprises a diode laser and a source lens. The source lens is a low-cost aspheric molded glass lens, which serves to pre-collimate but not to fully collimate the beam emanating from the laser diode.

In the preferred embodiment, the beam shaping sub-system comprises a cylindrical lens for focusing the exposure beam along one axis. This renders the beam in a form required for the scanning sub-system. Moreover, the beam shaping sub-system further comprises a singlet lens and a doublet lens for generating a collimated beam in combination with the cylindrical lens in one implementation.

To provide for adjustability to accommodate changes in the beam that could occur when the laser source sub-system is replaced in the field, for example, some lens elements are provided on movable stages. In one embodiment, a singlet lens stage is provided for the singlet lens and a cylindrical lens stage is provided for the cylindrical lens in order to adjust their position along the optical axis. This further allows the system to adapt to the fact that different laser diodes operate at slightly different wavelengths. That is, it is typical that the specification for the laser diodes allows for some variability in their wavelength, such as between 400 and 410 nanometers (nm). Adding this degree of adjustability allows for the system to collimate beams having slightly different wavelengths to compensate for the dispersiveness of the optics used in the system.

The scanning sub-system in the preferred embodiment comprises a scanning device, such as a rotating polygon and an anamorphic post-scanning optics for relaying the exposure beam from the scanning device to the print media in the “cross-scan” dimension (y) and focusing the collimated beam onto the print media in the “in-scan” dimension (x).

In general, according to another aspect, the invention features a media exposure system. This comprises a laser source sub-system that generates an exposure beam. A beam shaping sub-system shapes the exposure beam and includes at least one optical element stage for changing distances between the optical elements in the beam shaping sub-system and/or relative to the laser source sub-system to control the shaping of the exposure beam to compensate for changes in wavelength and alignment accuracies (e.g. distance between the diode and the aspheric lens). A scanning sub-system is provided that scans the exposure beam over the printing media.

In the case of a field failure of, for example, the violet laser diode, field service would be able to replace the rather inexpensive laser source sub-system, instead of the entire pre-scan optics bench or bed. This replacement can be done relatively easily. Moreover, this configuration eases the design for the collimator since it provides for the ability to compensate for wavelength aberrations that can occur with different laser diode output wavelengths. Thus, the present invention is more versatile, while still maintaining performance since the function of collimation is distributed over several, inexpensive optical elements, some of which are moveable on motorized z-stages.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram of a platesetter/imagesetter to which the present invention is applicable;

FIG. 2 is a schematic diagram of a media exposure system to which the present invention is applicable; and

FIG. 3 is a schematic view of the replaceable laser source sub-system and beam shaping sub-system of the inventive media exposure system.

### DETAILED DESCRIPTION OF THE PREFERRED EMBODIMENTS

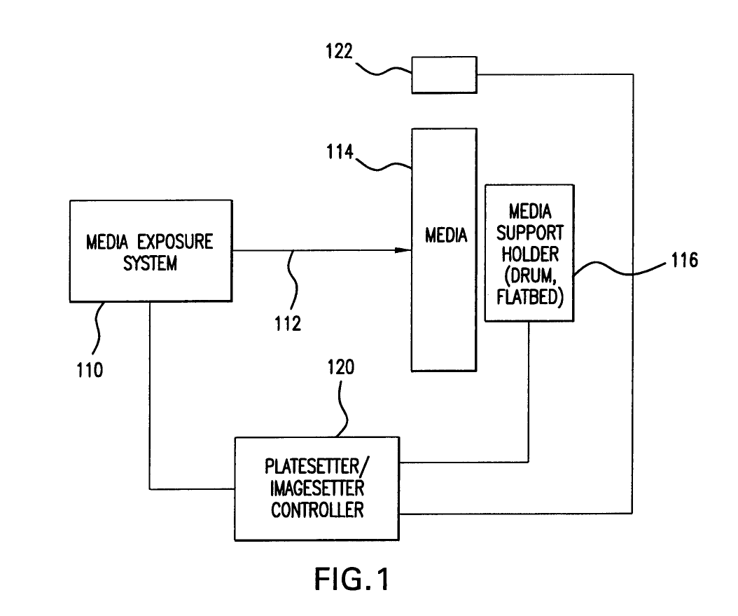

FIG. 1 shows the general organization of a platesetter or imagesetter.

Specifically, it comprises a media exposure system 110. This generates an exposure beam 112 that is scanned over the printing media 114. In one example, this printing media is a plate. In other examples, it can be film, which is then used to make plates for the offset printing system.

The printing media 114 is held by a media support holder 116. Typically, this holder 116 is a drum. Drums are either internal or external, referring to whether the printing media is wrapped over the inside or outside of the drum. In other examples, however, the media holder 116 is a flat bed system.

The media holder 116 and the media exposure system 1 10 are controlled by the platesetter/imagesetter controller 120, which controls the system's overall operation.

In one embodiment, an exposure beam detector 122 is provided to detect the characteristics of the exposure beam 112 during a calibration process, for example.

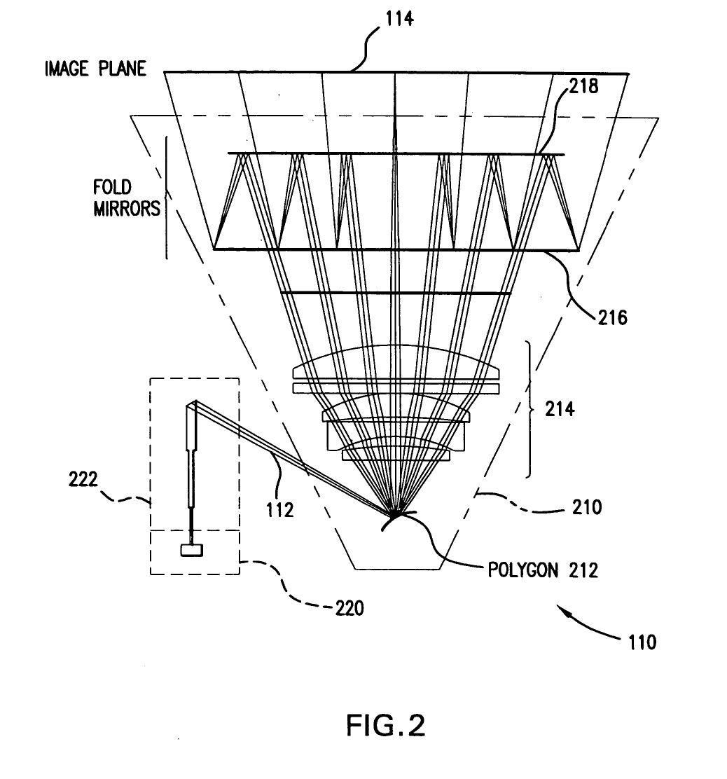

FIG. 2 shows the media exposure system 110, according to one embodiment. It generally comprises a scanning sub-system 210. This receives an exposure beam 112 to then scan that exposure beam over the printing media 114. This printing media is located at the image plane of the optics.

In the current embodiment, the exposure beam is scanned using a polygon 212. This is a multi-sided reflective instrument that spins in order to scan the exposure beam 112 over the printing media 114 at the image plane.

Post polygon optics 214 are further provided to focus the exposure beam down onto the image plane 214. Fold mirrors 216 and 218 are provided to set the path length and to guide the exposure beam to the printing media.

According to the invention, the exposure beam 112 is generated by a field-replaceable laser source sub-system 220. This typically includes a semiconductor laser that generates a relatively short wavelength beam, such as a beam having a wavelength of less than 500 nanometers (nm). In the present embodiment, the wavelength is between 400 and 410 nm, in the violet region of the spectrum.

This beam is then provided to a beam shaping sub-system 222. This collimates the beam and also then focuses the beam along one axis so that it can be scanned by the polygon 212. Focusing the beam along one axis onto the polygon is “state of the art” in scanner designs to control cross-scan image errors generated by scanner wobble. The primary purpose of doing the focusing is the so-called “wobble” correction. By not doing the focusing any wobble of the polygon perpendicular to the scanning direction would lead to a walking beam in the image plane and therefore displace the pixel on the printing media in a direction perpendicular to the scan-line.

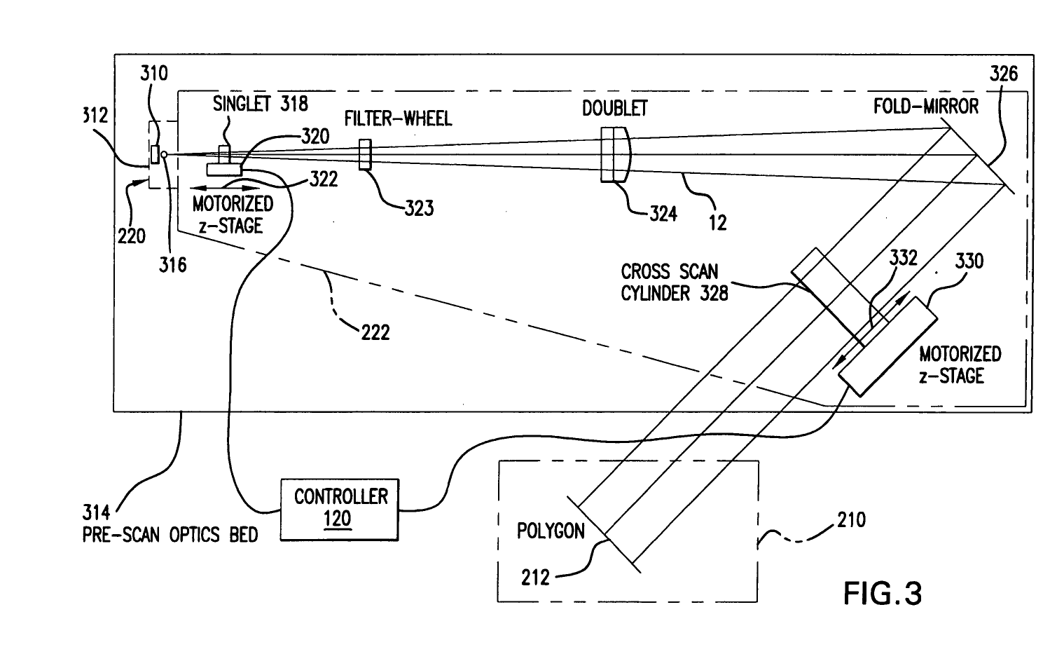

FIG. 3 shows the field replaceable laser source sub-system 220 and the beam shaping sub-system 222, according to the preferred embodiment.

Specifically, a semiconductor diode laser chip 310 is provided on a diode laser submount 312. This provides a mechanism for attaching the diode laser 310 onto an optics bed 314 that provides mechanical rigidity and stability to and between the field-replaceable laser source sub-system 220 and the beam shaping sub-system 222. A source lens 316 is further provided on the diode laser submount 312. This lens begins the process of collimating the beam from the diode laser 310.

Typically, diode lasers will generate a beam with a relatively high aspect ratio that has different divergence angles along each of the x and y axes, which are defined as perpendicular to the optical axis or parallel to the direction of light propagation. The y axis is perpendicular to the bed 314, and the x axis is parallel to the bed 314. In order to collimate the divergent output beams from the laser diode, the collimating lens 316 is necessary. In typical conventional designs a fixed focal length collimating lens is used to collimate the beam in both the x and y axes. This lens has to be color corrected in order to work properly for different laser diode wavelengths and has to be corrected for high order spherical aberrations which would occur because of the high numerical aperture (NA) output beam of the laser diode in at least one axis (NA>0.2).

The demands of the complex lens design with tight manufacture and assembly tolerances and the requirement that the distance between the laser diode 310 and the collimating lens 316 has to be held very accurately (to within less than a micrometer) make the fixed focal length collimators expensive. Requirements of rigid mechanical mounting of the collimating lens with respect to the diode means that once the alignment is completed it must be secured (frozen for example with glue or solder). Material and mounting techniques have to be considered during the design phase to assure that changes in temperature will not cause misalignments or performance degradations beyond prescribed limits. A later realignment in conventional collimator designs is not possible.

The output beam of the laser diode 310 typically has different numerical apertures in the x- and y-directions (a standard Nichia violet 30 mW laser diode typically has a 23 degree (NA=0.2) full width half maximum (FWHM) divergence in the so-called “fast axis” (in this application the fast axis coincides with the x-direction) and typically an 8 degree (NA=0.07) FWHM divergence in the so-called “slow axis” (which is in the application coincident with the y-direction). The divergence angle of the laser diode output beam is directly related to diameter of the waist of the beam at the emitter of the diode. For a laser diode that operates at 400 nm the above described diode divergence parameters lead to FWHM diameters of the beam waist at the emitter of about 0.5 micron in x and about 1.2 micron in y. Those beam waists define the dimension of the “object” and are relayed by the optics to an image on the printing media. The spot-size in the image plane 114 therefore depends on the optical magnification of the relay optics. So, in order to achieve a symmetric circular spot in the image plane an anamorphic optical relay system is required that provides different optical magnifications in the x- and the y-directions.

For example, in order to achieve a circular spot in the image plane of about 15 micrometers FWHM diameter, starting with a 23 by 8 degree FWHM divergence and a 400 nm diode wavelength, an optical magnification factor mₓ of about 30 is necessary in the x-direction but only a magnification factor m_{y} of 12 in the y-direction. This demands an anamorphic design of the relay optics and requires the use of cylindrical lenses or mirrors in the relay optics.

For a perfect alignment (correct diode-collimating lens distance) the x-focus and y-focus (focus in the x-axis and y-axis, respectively) would overlay at the same z-position in the image plane, exactly where the printing material is positioned.

Considering now a laser-diode failure in the field where the diode collimating lens sub-module has to be replaced, field service would take out the old sub-assembly and replace it by a pre-aligned new sub-assembly. The opto-mechanical interface, for example, would be realized by holes on the sub-assembly mounting plate matched position-wise with the locations of pins on the optics bed 314 so that the mechanical position of the new sub-assembly is determined.

As mentioned earlier, the pre-alignment of the distance between the diode and the collimating lens of the sub-module can be done only within a certain accuracy (usually a couple of micrometers) and any slight misalignment (Δz) in the diode-collimating lens distance would immediately result in an astigmatic focus shift and dramatically deteriorate the image quality. The reason is that the misalignment error Δz would be magnified by the factor (mₓ)² in the x-direction but only by the factor (m_{y})² in the y-direction. As a consequence the x-focus would be shifted by Δz*(mₓ)² in the z-direction away from the printing media. The y-focus would be shifted by Δz*(m_{y})² in the z-direction away from the printing media. Since mₓ <>m_{y} the x- and y-focus do not shift by the same amount leading to an astigmatic focus in the image plane which cannot be taken out by simply refocusing the printing media. Let us consider for example the effect of a diode-collimating lens misalignment error of Δz=1 micrometers. Based on the above mentioned magnification factors mₓ and m_{y} the x-focus would shift by 900 micrometers and the y focus by 144 micrometers in the same direction. The residual astigmatism between the x- and y- focus position would be 756 micrometers, which exceeds the typical depth of focus for this scanner post polygon optics (PPO) and usually far too much to give an acceptable image quality.

In conventional collimator designs a typical way out of this dilemma was to move for example a cylindrical lens and some mirrors in the z-direction in order to affect the x- or y-focus independently from each other to overlay the two foci in the image plane. But in order to execute successfully such movements field service not only has to touch the optical element after the installation of the diode-asphere sub-module when the laser beam is “on” but also has to judge the success of the movement of those elements by somehow evaluating the impact of the alignment on focus and image quality. But field service are not always trained with lasers and are for safety reasons not always allowed to work with the machine when the laser is “on”. To circumvent that issue, a lot of “blind” alignment iterations where often necessary in order to optimize the machine with the laser “off”. These “blind” alignment iterations are time consuming and expensive with limited success. By executing these alignments the idea of modularity for a field replacement gets lost.

The invention presented here circumvents the dilemma described above. Instead of concentrating all of the optical power into one sophisticated and expensive fixed focal length collimator with the disadvantages described above, in the present invention the power is distributed over a source lens 316, a singlet lens 318, and a doublet lens 324 that are simple and inexpensive elements. In one implementation, this source lens 316 is an aspheric “off-the-shelf” lens. It is prealigned to the diode laser 310 on the submount 312, where it is affixed with a fine thread and set screws. The nature of these submounts and lenses, however, leads to the possibility for slight misalignments between the diode laser 310 and the source lens 316.

Next, in the optical train, a singlet lens 318 is provided. This is held on a precision z-stage 320, which is controlled by the controller 120. This motorized z-stage 320 allows the singlet lens to be moved in the direction of the optical axis 322. This allows for the control of the collimation of the exposure beam 112. A doublet 324 is further provided. This provides the collimation of the exposure beam 112, and some wavelength compensation. Specifically, a doublet is a two lens arrangement designed to correct for spherical aberration and chromatic is dispersion.

The source lens 316 is used to collect and converge the exposure beam, but not fully converge it. This is accomplished through the use of the singlet lens 318 and the doublet 324 to get the required expansion. To be more specific: The optical power distribution happens first by using a low cost off-the-shelf asphere 316. By almost but not perfectly collimating the diode output with this aspherical lens a lot of “stress” is taken away from the optical design, making the beam path much more relaxed. The singlet lens 318 is a simple inexpensive plano-concave glass lens element. This singlet 318 has negative power and diverges the beam. A cemented doublet lens 324 is used next with two different glass materials for color correction.

The doublet further collimates the divergent beam, forming an appreciably collimated beam with different diameters in the slow and fast axis resulting in an elliptical profile. The asphere-singlet-doublet combination represents the actual collimator for the laser diode output. The singlet doublet combination acts as a beam expander that expands the beam to the appropriate beam diameter and also perfectly collimates the quasi-collimated beam after the aspherical lens.

In one example, a fold mirror 326 is further provided to direct the beam. Next, a cross-scan lens 328 is provided. This is a cylinder lens that focuses the beam along one axis onto the polygon facet.

In the preferred embodiment, a cross-scan cylinder lens z-stage 330 is provided to adjust the position of this cylinder lens 328 in the direction of the optical axis 332. This cylinder lens z-stage 330 is controlled by the controller 120, in order to control the focus position of the beam, in the axis of the cylinder lenses 328 focus, and correct for astigmatism at the final image plane.

In the case of a possible diode failure in the field, as described earlier, a replacement of the diode—source lens sub-assembly, could lead to astigmatism. But instead of having to touch and move lens elements or mirrors by hand, field service can now take advantage of the motor driven lens elements. Without having to open the machine, field service would be able to optimize the alignment (getting rid of any astigmatism in the focus on the printing media) by controlling the position of the singlet lens 318 and the cylinder lens 328 with the motor driven z-stages 320, 330. By changing the position of the singlet lens 318, the focal length of the 3-element collimator can be changed, moving the position of the x- and the y-focus in the image plane. By watching only the movement of the x-focus in the image plane, it is possible to refocus the system in x to assure that the x-focus coincides with the position of the printing media. As an example: In the present design, a singlet movement of 0.21 millimeters (mm) shifts the x-focus in the image plane by 1.0 mm in the z-direction.

In a second step the residual astigmatism would be taken out by moving the cylinder lens 328. Since the cylinder lens 328 affects only the focus in the y-direction at the image plane it is possible to refocus the y-focus onto the printing media and overlay it with the already optimized position of the x-focus. As an example: In the present design, a cylinder movement of 1.7 mm shifts the y-focus in the image plane by 1.0 mm in the z-direction.

With the present invention, it is possible to simulate the through-focus behavior of the system, by controlling the motorized elements using feedback from the exposure beam detector 122. It is possible to create true two-dimensional focus maps, without having to manually adjust any sensitive elements. This helps the search for the best focus at the image plane.

Furthermore, this invention even allows the use of lenses that are highly dispersive and are designed to operate at other wavelengths, such as 780 nm. According to the invention, the correction is distributed over three elements. This allows for collimation in both the X and Y axes of the beam.

A filter wheel 323 is further provided. The purpose of the filter wheel is to be able to control the exposure in the image plane 114 by attenuating the beam more or less depending on the plate material sensitivity. The filter wheel is a plan-parallel glass plate that can be rotated about the z-axis. It is equipped with a special coating where the transmittance of the coating changes continuously with the angular position of the filter wheel. The range of the transmittance goes from 100% at a zero degree filter wheel rotational angle down to almost zero transmission at an about 270 degree rotational angle which means that no power goes is through the filter wheel.

The calibration process for the replaceable diode-source-lens sub-module is straightforward. Because of the fact that it is possible to refocus misalignment errors in the diode-source lens distance (which is by far the most important alignment error because of sensitivity reasons) with the help of the motorized singlet 318 and cylinder lens 324 later in the system, it is mainly necessary to ensure that the required movement of those two lenses do not exceed the range of possible travel, which is limited by the length of the z-stages.

During the pre-alignment process the diode-source lens sub-assembly (which is a field replaceable module) is combined on a so-called “master” tool with a permanently residing singlet and doublet lens. The beam after the doublet is evaluated with a “Shear” plate. The Shear plate is an interferometric tool that provides information about the degree of collimation of a beam.

When the source lens is mounted to the diode mounting plate the distance between the diode and the source lens can be judged by watching the interferometric pattern on the Shear plate screen. By applying this simple method it is possible to adjust the diode-source lens distance to within a few microns and therefore to limit the focus and astigmatism error in the image plane to an amount which can be easily taken out by moving the singlet and cylinder accordingly as described earlier.

The system is equipped with a calibration device 122, which includes for example a set of gratings and photo-detectors behind. The grating is positioned where the media and therefore where the focus of the exposure beam is supposed to be. The grating is usually a few millimeters wide with typically 500-1000 line-pairs per millimeter leading to a spacing of about 10-20 micrometer, which is about the size of the beam itself. It can be realized for example by a special coating with alternating transmittance properties so that the beam when it scans over the grating is alternately transmitted or blocked by the grating. As a result the beam is modulated in intensity when it hits the photo-detector. The modulation depth of this modulated photo-detector signal is a measure for the spot size of the beam that scans over the grating. The smaller the spot size, the more light intensity reaches the detector when the beam passes the gaps of the grating and therefore the bigger is the change in intensity between a blocked beam and a transmitted beam. When the exposure beam is out of focus, the spot size in the image plane where the exposure medium and therefore the calibration grating and detector sits, would be too large, leading to an almost un-modulated detector signal. Best focus is determined by the highest achievable modulation depth.

With the correct choice of grating geometry it is possible to detect the spot size in the x- and y-direction simultaneously so that x- and y-focus can be judged independently from each other.

In the invention presented here, field service for example would be able to optimize the x- and y-focus by moving as explained above the singlet and cylinder in the pre-scan optics, judging the success of their efforts in real time by observing the modulation depth on the calibration sensor.

While this invention has been particularly shown and described with references to preferred embodiments thereof, it will be understood by those skilled in the art that various changes in form and details may be made therein without departing from the scope of the invention encompassed by the appended claims.

1. A media exposure system, comprising:
a field-replaceable laser source subsystem that generates an exposure beam;
a beam shaping subsystem that shapes the exposure beam; and
a scanning subsystem that scans the exposure beam over printing media.

2. A media exposure system as claimed in claim 1, wherein the field-replaceable laser source subsystem comprises a diode laser and a source lens.

3. A media exposure system as claimed in claim 2, wherein the source lens is aspheric.

4. A media exposure system as claimed in claim 1, wherein the field-replaceable laser source subsystem comprises a short wavelength diode laser.

5. A media exposure system as claimed in claim 4, wherein the short wavelength diode laser operates at less than about 500 nanometers.

6. A media exposure system as claimed in claim 1, wherein the beam shaping subsystem comprises a singlet lens and a doublet lens to improve a collimation of the exposure beam.

7. A media exposure system as claimed in claim 6, wherein the beam shaping subsystem further comprises a singlet lens stage for adjusting a position of the singlet lens in a direction of an optical axis.

8. A media exposure system as claimed in claim 6, wherein the beam shaping subsystem further comprises a cylindrical lens for focusing the exposure beam along one axis.

9. A media exposure system as claimed in claim 8, wherein the beam shaping subsystem further includes a cylindrical lens stage for adjusting a position of the cylindrical lens in a direction of an optical axis.

10. A media exposure system as claimed in claim 9, wherein the beam shaping subsystem further includes a singlet lens stage for adjusting a position of the singlet lens in a direction of an optical axis.

11. A media exposure system as claimed in claim 1, wherein the beam shaping subsystem comprises a cylindrical lens for focusing the exposure beam along one axis.

12. A media exposure system as claimed in claim 1, wherein the beam shaping subsystem comprises at least one optical element stage for changing distances between optical elements in the beam shaping subsystem and/or relative to the field replaceable laser source to control the shaping of the exposure beam.

13. A media exposure system as claimed in claim 1, wherein the beam shaping subsystem comprises two optical element stages.

14. A media exposure system as claimed in claim 1, wherein the beam shaping subsystem comprises at least one optical element stage for changing distances between optical elements in the beam shaping subsystem and/or relative to the field replaceable laser source to control the shaping of the exposure beam to compensate for changes in a wavelength, shape and/or divergence angle of the exposure beam from the field-replaceable laser source.

15. A media exposure system as claimed in claim 1, wherein the scanning subsystem comprises a scanning device and post scanning optics for relaying the exposure beam from the scanning device to the printing media.

16. A media exposure system, comprising:
a laser source subsystem that generates an exposure beam;
a beam shaping subsystem that shapes the exposure beam and includes at least one optical element stage for changing distances between optical elements in the beam shaping subsystem and/or relative to the laser source subsystem to control the shaping of the exposure beam to compensate for changes in a wavelength, shape and/or divergence angle of the exposure beam from the laser source subsystem; and
a scanning subsystem that scans the exposure beam over printing media.

17. A media exposure system as claimed in claim 16, wherein the laser source subsystem comprises a diode laser and a source lens.

18. A media exposure system as claimed in claim 17, wherein the source lens is aspheric.

19. A media exposure system as claimed in claim 17, wherein the laser source subsystem comprises a short wavelength diode laser.

20. A media exposure system as claimed in claim 19, wherein the short wavelength diode laser operates at less than about 500 nanometers.

21. A media exposure system as claimed in claim 16, wherein the beam shaping subsystem comprises a singlet lens and a doublet lens to improve a collimation of the exposure beam.

22. A media exposure system as claimed in claim 21, wherein the beam shaping subsystem further includes a singlet lens stage for adjusting a position of the singlet lens in a direction of an optical axis.

23. A media exposure system as claimed in claim 22, wherein the beam shaping subsystem further comprises a cylindrical lens for focusing the exposure beam along one axis.

24. A media exposure system as claimed in claim 23, wherein the beam shaping subsystem further includes a cylindrical lens stage for adjusting a position of the cylindrical lens in a direction of an optical axis.

25. A media exposure system as claimed in claim 24, wherein the beam shaping subsystem further includes a singlet lens stage for adjusting a position of the singlet lens in a direction of an optical axis.

26. A media exposure system as claimed in claim 16, wherein the beam shaping subsystem comprises a cylindrical lens for focusing the exposure beam along one axis.
